(19) United States
(12) Patent Application Publication
(10) Pub. No.: US 2019/0126601 A1
(43) Pub. Date: May 2, 2019

(54) GAS BARRIER FILM AND PACKAGING MATERIAL

(71) Applicants: TOPPAN PRINTING CO., LTD., Tokyo (JP); TOPPAN USA, INC., Griffin, GA (US)

(72) Inventors: Tomokazu Murase, Tokyo (JP); Rebecca Harman, Griffin (GA)

(73) Assignees: TOPPAN PRINTING CO., LTD., Tokyo (JP); TOPPAN USA, INC., Griffin, GA (US)

(21) Appl. No.: 15/801,382

(22) Filed: Nov. 2, 2017

(51) Int. Cl. B32B 27/18; C08K 3/34; B32B 27/08; B32B 27/30; C09D 129/04; C09D 7/12

(52) U.S. Cl. CPC B32B 27/18; C08K 3/34; B32B 27/08; B32B 27/306; C09D 129/04; B32B 2307/7246; C08K 2201/008; B32B 2439/70; B32B 2439/80; B32B 2307/7248; C09D 7/1216

(57) ABSTRACT

A gas barrier film comprises a first base material film made of a plastic material and a coating layer formed on one of surfaces of the first base material film, the coating layer contains a water-soluble polymer and a water-swelling mica, the solid content ratios of the water-swelling mica in a total solid content of the coating layer are within approximate ranges indicated from 20 mass % to 50 mass %, the mean area diameter of the water-swelling mica is within approximate ranges indicated from 0.5 μm to 5 μm, and the thickness of the coating layer is within approximate ranges indicated from 0.1 μm to 1 μm.

### BACKGROUND OF THE INVENTION

### Field of the Invention

This invention relates to a gas barrier film to limit moisture and/or oxygen that can be used a packaging material. The packaging material to package foods, such as dried foods, confectionaries, breads and pastries, delicacies and the like, or also for medical goods such as tablets, powders, poultices, adhesive skin patches and the like. (Of course, other materials can be packaged.) Particularly, the invention relates to a gas barrier film used in packaging fields for applications requiring high gas barrier properties and also having a transparency to still enable visual recognition of the contents. Also, this invention relates to packaging materials comprising the new gas barrier film.

### Description of the Related Art

Packaging materials used for foods and medical goods should include properties (e.g., gas barrier properties) that slow or even stop the permeation of water vapor, oxygen and other gases capable of causing content quality to be deteriorated. Such properties will suppress the contents from being deteriorated or decayed and to aid in retaining the function and properties of foods and medical goods.

Therefore, packaging materials have been provided thus far to include a gas barrier layer made of a material having gas barrier properties. Until now, the gas barrier layer has been formed on a base material such as a film or paper according to a sputtering or vacuum deposition method, or a wet coating or printing method. The gas barrier layer used thus far can include a metal foil or metal deposition film made of a metal such as aluminum, or a resin film such as of polyvinyl alcohol, an ethylene/vinyl alcohol copolymer, polyvinylidene chloride or the like.

In order to improve the gas barrier properties of these resin films, there has been proposed composite resin films of resins and inorganic layered minerals. For example, these proposed composite resin films have been described, for example, in U.S. Pat. Nos. 5,700,560 and 5,981,029. With these types of composite resin films, it is necessary that an inorganic layered mineral be distributed and arranged in order in the inside of the film so as to allow improved gas barrier properties. However, as the inorganic layered mineral is distributed and arranged in order, the cohesive force of the resin film and the adhesion force of the film to a base material can become lower. Thus, it is very difficult to satisfy both the high gas barrier properties and the adhesion strength sufficient for use as a packaging material.

### BRIEF SUMMARY OF THE INVENTION

The present invention has been made under such circumstances of the prior art as stated above and has for an object the provision of a gas barrier film that has both improved gas barrier properties and has adhesion strength and cohesive strength of a resin film sufficient for use as a packaging material. Also, the invention has for an object the provision of a packaging material that has improved gas barrier properties and sufficient laminate strength.

A gas barrier film to a first embodiment of the invention comprises a first base material film made of a plastic material and a coating layer formed on one of surfaces of the first base material film, wherein the coating layer contains a water-soluble polymer and a water-swelling mica, the solid content ratios of the water-swelling mica in a total solid content of the coating layer being within approximate ranges indicated from 20 mass % to 50 mass %, the mean area diameter of the water-swelling mica being within approximate ranges indicated from 0.5 μm to 5 μm, and the thickness of the coating layer being within approximate ranges indicated from 0.1 μm to 1 μm.

In the first embodiment of the invention, the water-soluble polymer may be polyvinyl alcohol resin and the degree of polymerization of the polyvinyl alcohol resin may be within approximate ranges indicated from 1,100 to 2,300.

In the first embodiment of the invention, the aspect ratio of the water-swelling mica may be within approximate ranges indicated from 10 to 200.

In the first embodiment of the invention, the mean area diameter of the water-swelling mica may be within approximate ranges indicated from 1.5 μm to 2.5 μm and the thickness of the coating layer may be within approximate ranges indicated from 0.15 μm to 0.7 μm.

A gas barrier film to the first embodiment of the invention comprises a base material film made of a plastic material and a coating layer formed on one of surfaces of the first base material film. The components and thickness of the coating layer are controlled within given ranges, so that there can be obtained a gas barrier film that has both improved gas barrier properties and has adhesion strength and cohesive strength of a resin film sufficient for use as a packaging material.

A packaging material to a second embodiment of the invention comprises a first film, a second film and an adhesive layer formed between the first film and the second film, wherein the first film comprises a first base material film made of a plastic material and a coating layer formed between the first base material film and the adhesive layer, the second film comprises a second base material film made of a plastic material, the coating layer comprises a water-soluble polymer and a water-swelling mica, the solid content ratios of the water-swelling mica in a total solid content of the coating layer being within approximate ranges indicated from 20 mass % to 50 mass %, the mean area diameter of the water-swelling mica being within approximate ranges indicated from 0.5 μm to 5 μm, and the thickness of the coating layer being within approximate ranges indicated from 0.1 μm to 1 μm.

In a second embodiment of the invention, the second film may further comprise an ink layer formed between the second base material film and the adhesive layer.

In the second embodiment of the invention, the first film may further comprise an ink layer formed between the coating layer and the adhesive layer.

In the second embodiment of the invention, the first base material film and the second base material film may be made of a same plastic material.

In the second embodiment of the invention, the water-soluble polymer may be polyvinyl alcohol resin and the degree of polymerization of the polyvinyl alcohol resin may be within approximate ranges indicated from 1,100 to 2,300.

In the second embodiment of the invention, the aspect ratio of the water-swelling mica may be within approximate ranges indicated from 10 to 200.

In the second embodiment of the invention, the mean area diameter of the water-swelling mica may be within approximate ranges indicated from 1.5 μm to 2.5 μm and the thickness of the coating layer may be within approximate ranges indicated from 0.15 μm to 0.7 μm.

A packaging material made of this second embodiment of the invention comprises two films and an adhesive layer formed between the two films. One of the two film is the gas barrier film, the other film comprises a base material film made of a plastic material. The components and thickness of the coating layer of the gas barrier film are controlled within given ranges, so that there can be obtained a gas barrier film that has improved gas barrier properties and sufficient laminate strength.

### BRIEF DESCRIPTION OF THE SEVERAL VIEW OF THE DRAWING

FIG. 1 is a cross sectional view illustrating a structure of a gas barrier film exemplified in an embodiment of the invention.

FIG. 2 is a cross sectional view illustrating a structure of a packaging material exemplified in an embodiment of the invention.

FIG. 3 is a cross sectional view illustrating another structure of a packaging material exemplified in an embodiment of the invention.

FIG. 4 is a cross sectional view illustrating another structure of a packaging material exemplified in an embodiment of the invention.

### DETAILED DESCRIPTION OF THE INVENTION

Representative embodiments of the present invention are set forth, below. It is to be understood that the present invention is not necessarily limited to the following embodiments These embodiments are illustrative and one of skill in the art could understand how to modify the representative embodiments for practicing the present invention in ways other than described, below.

[Gas Barrier Film]

The gas barrier film of a first embodiment of the invention comprises at least a base material film made of a plastic material and a coating layer formed on one of surfaces of the first base material film.

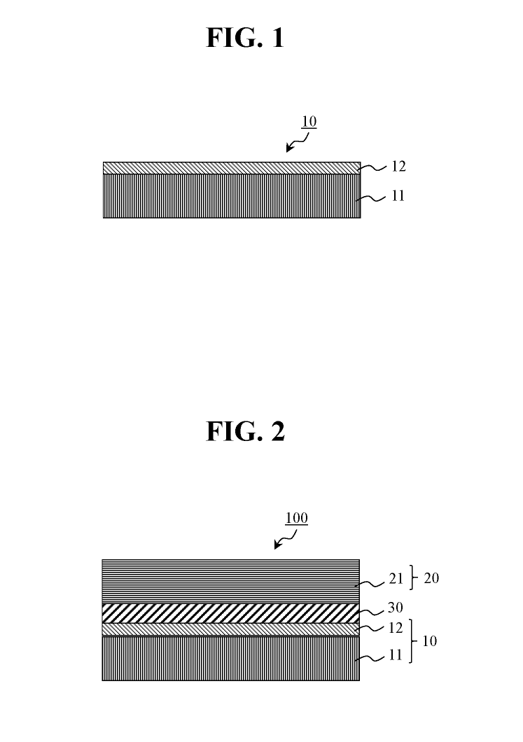

FIG. 1 is a cross sectional view illustrating a structure of a gas barrier film exemplified in an embodiment of the invention. As shown in FIG. 1, there is provided a gas barrier film 10 which includes a first base material film 11 made of a plastic material and a coating layer 12 formed on one of surfaces of the first base material film 11.

The gas barrier film of the embodiment of the invention may have, if necessary, an anchor coat layer formed between the base material film and the coating layer, an overcoat layer formed on the surface of the coating layer, or a heat seal layer formed on one or both of surfaces of the gas barrier film.

[Packaging Material]

The packaging material of the embodiment of the invention comprises at least two films and an adhesive layer formed between the two films. One of the two films is the gas barrier film and the other film comprises a base material film made of a plastic material.

FIG. 2 is a cross sectional view illustrating a structure of a packaging material exemplified in an embodiment of the invention. As shown in FIG. 2, there is provided a packaging material 100 which includes a first film 10, a second film 20 and an adhesive layer 30 formed between the first film 10 and the second film 20. There is provided the first film 10 which includes a first base material film 11 made of a plastic material and a coating layer 12 formed between the first base material film 11 and the adhesive layer 30, there is provided the second film 20 which includes a second base material film 21 made of a plastic material.

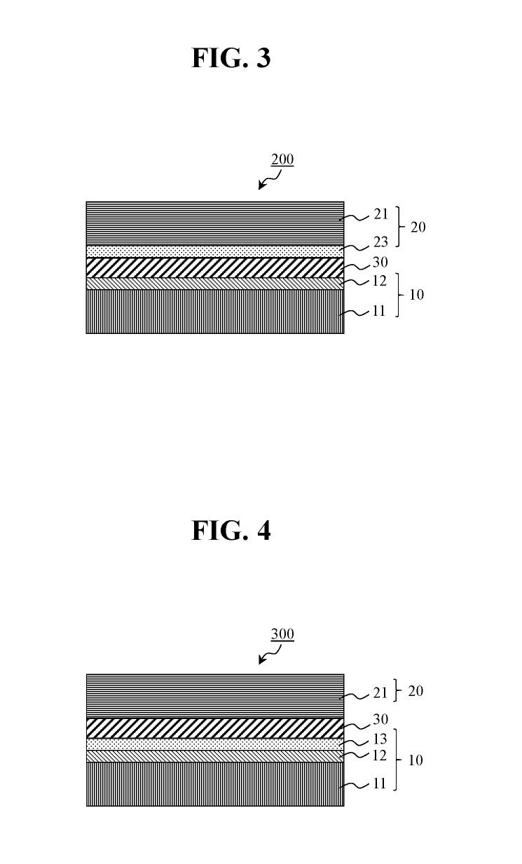

FIG. 3 is a cross sectional view illustrating another structure of a packaging material exemplified in an embodiment of the invention. As shown in FIG. 3, there is provided a packaging material 200 which includes a first film 10, a second film 20 and an adhesive layer 30 formed between the first film 10 and the second film 20. There is provided the first film 10 which includes a first base material film 11 made of a plastic material and a coating layer 12 formed between the first base material film 11 and the adhesive layer 30. There is provided the second film 20 which includes a second base material film 21 made of a plastic material and an ink layer 23 formed between the second base material film 21 and the adhesive layer 30.

FIG. 4 is a cross sectional view illustrating another structure of a packaging material exemplified in an embodiment of the invention. As shown in FIG. 4, there is provided a packaging material 300 which includes a first film 10, a second film 20 and an adhesive layer 30 formed between the first film 10 and the second film 20. There is provided the first film 10 which includes a first base material film 11 made of a plastic material, a coating layer 12 formed on one of surfaces of the first base material film 11, and an ink layer 13 formed between the coating layer 12 and the adhesive layer 30. There is provided the second film 20 which includes a second base material film 21 made of a plastic material.

The packaging material of the embodiment of the invention may have, if necessary, a heat seal layer formed on one or both of surfaces of the packaging material.

[Base Material Film]

The base material film is made of a plastic material. For the base material film made of a plastic material, mention is made, for example, of those films of polyolefin resins such as polyethylene, polypropylene, propylene-ethylene copolymers and the like, polyester resins such as polyethylene terephthalate, polybutylene terephthalate and the like, aliphatic polyamides such as nylon 6 and nylon 66, polyamide resins including aromatic polyamides such as polymethaxylylene adipamide and the like, vinyl resins such as polystyrene, polyvinyl acetate, ethylene-vinyl acetate copolymer, polyvinyl alcohol, ethylene-vinyl alcohol copolymer and the like, acrylic resins including homopolymers or copolymers of (meth)acrylic monomers such as polymethyl methacrylate, polyacrylonitrile and the like, and cellophane. These resins may be used singly or in combination of two or more.

Of these, preferred base material films include polyolefin resin films (specifically, a polypropylene film), polyester resin films (specifically, a polyethylene terephthalate resin film), and polyamide films (specifically, nylon films).

For the base material film, there is used a single-layer film constituted of a single resin, or a single-layer film or laminate film making use of a plurality of resins. Alternatively, laminate base materials of the type wherein these resins are laminated on other types of base materials (such as metals, wood pieces, paper, ceramics and the like) may be used.

The base material film may be either an unstretched film, or a uniaxially stretched film or biaxially stretched film. Those films subjected to a surface treatment (corona discharge treatment), anchor coating, or an undercoating treatment may also be used.

When the base material film is subjected to a corona treatment, low temperature plasma treatment, atmospheric pressure plasma or the like on a surface to be coated (i.e. a surface on which a film is formed), good wettability to a coating agent and good adhesion to film are ensured.

The thickness of the base material film is not critical and may be appropriately selected depending on the cost and purpose in use while taking fitness for packaging material and lamination aptitude of other type of film into account. The thickness of the base material film is in practice at 3 to 200 μm, preferably at 5 to 120 μm and more preferably at 10 to 100 μm.

Among the two base material films (the first base material film and the second base material film) which are used for the packaging material, the second base material film may be a base material film having heat sealing properties. For the base material film having heat sealing properties, mention is made, for example of unstretched polyethylene films or unstretched polypropylene films.

The two base material films (the first base material film and the second base material film) which are used for the packaging material are preferably made of a same plastic material. The same plastic material means that the plastic materials of the main components constituting the two base material films are the same, and other components may be contained. In the case where the two films are the same plastic material, the packaging material can be torn linearly. In other words, when the packaging material is formed in a bag shape, the bag can be easily opened. In addition, since the shrinkage rates of the two base material films become substantially equal, it is possible to suppress the cohesion strength of the coating layer and the adhesion strength of the coating layer to the base material from decreasing due to external force as time passes. The two base material films are preferably polyolefin resin films (specifically, a polypropylene film), polyester resin films (specifically, a polyethylene terephthalate resin film, and the like. Especially, both of the two base material films are more preferably biaxially stretched films.

[Coating Layer]

The coating layer of the embodiment of the invention contains at least a water-soluble polymer and one or more water-swelling micas.

[Water-Soluble Polymer]

The water-soluble polymer means one that is completely dissolved in or finely dispersed in water at a specific temperature. The water-soluble polymer is not specifically limited so far as it is able to permit interstitial invasion or intercalation between unit crystal layers of an inorganic layered mineral described hereinafter. For example, mention is made of polyvinyl alcohol and derivatives thereof, cellulose derivatives such as carboxymethyl cellulose, hydroxyethyl cellulose and the like, starches such as oxidized starch, etherized starch, dextrin and the like, polyvinylpyrrolidone, polyacrylic acid and polymethacrylic acid or esters, salts and copolymers thereof, copolymerized polyesters containing a polar group such as sulfoisophthalic acid, vinyl polymers such as polyhydroxyethyl methacrylate and copolymers thereof, urethane polymers, or a variety of the above-indicated polymers whose functional group, such as a carboxyl group, is modified.

The water-soluble polymer is preferably a polyvinyl alcohol resin whose degree of saponification is 95% or higher. With polyvinyl alcohol resin, higher degrees of saponification and polymerization tend to have lower hygroscopicity and swellability. In the case where the degree of saponification is 95% or higher, adequate gas barrier properties are likely to be obtained.

When the water-soluble polymer is a polyvinyl alcohol resin, the polyvinyl alcohol resin may contain, as at least one component, a polyvinyl alcohol polymer and its derivative.

A degree of polymerization of the polyvinyl alcohol resin is preferably at 1,100 to 2,300, and more preferably at 1,500 to 2,000. If the degree of polymerization of polyvinyl alcohol resin is within the above range, there can be obtained a film whose gas barrier properties and cohesive strength of the coating layer are improved. Especially, in the case where the degree of polymerization of polyvinyl alcohol resin is 1,100 or higher, preferably 1,500 or higher, there can be obtained a film whose gas barrier properties is further improved.

[Water-Swelling Micas]

The mica or micas mean a kind of an inorganic layered mineral wherein very thin unit crystal layers are superposed to form one layered particle. The micas include natural mica and synthetic mica. For example, mention is made of muscovite, phlogopite, biotite, potassium phlogopite, potassium tetrasilicic mica, sodium taeniolite, potassium fluortetrasilicic mica, sodium fluortetrasilicic mica, sodium phlogopite, sodium tetrasilicic mica, sodium hectorite, and the like. For purposes of this invention, one mica could be used or two or more different micas could be combined together.

For the micas, those that are able to be swelled and cleft in water are preferred. Among them, water-swelling micas having swellability in water are preferably used. More specifically, the synthetic micas are one which enables water to be intercalated between very thin unit crystal layers and thus, has properties of absorption and swelling, and is generally a compound wherein a layer of a tetrahedral structure formed by coordination of Si⁴⁺ with O²⁻ and a layer of an octahedral structure formed by coordination of Al³⁺, Mg²⁺, Fe²⁺, Fe³⁺ or the like with O²⁻ and OFF are bonded at a ratio of 1:1 or 2:1 and superposed to form a layered structure. For example, the sodium fluortetrasilicic mica is preferred.

From the standpoint that a high aspect ratio leads to improved barrier properties of film, preferably 10 to 200 and more preferably 50 to 150. If the aspect ratio of the water-swelling mica is within the above range, there is an increased chance that a film can be obtained whose gas barrier properties are improved, and at the same time it is possible to suppress decrease in the adhesion strength of the coating layer to a base material film and the cohesive strength of the coating layer.

Also, mean area diameter (MA) of the water-swelling mica is preferably at 0.5 to 5 μm, more preferably at 1 to 3 μm, and much more preferably at 1.5 to 2.5 μm. The mean area diameter is an average particle diameter weighted by area. If the mean area diameter of the water-swelling mica is within the above range, there can be obtained a film whose gas barrier properties and transparency are maintained or improved because the water-swelling mica is more uniformly dispersed in the coating layer without precipitation of the water-swelling mica.

When using a water-swelling synthetic mica as the water-swelling mica, the water-swelling synthetic mica is high in compatibility with the water-soluble polymer and has a reduced content of impurities over natural micas, so that gas barrier properties and cohesive strength of the coating layer are not lowered owing to the impurities. Without being limited to a specific mechanism, it is believed that because of the fluorine atom contained in the crystal structure, the water-swelling synthetic mica contributes to suppressing the humidity dependence of the gas barrier properties of the coating layer. Moreover, because of a higher aspect ratio than other types of water-swelling inorganic layered minerals, the tortuous pass works more effectively, and the water-swelling synthetic mica contributes to high development of gas barrier properties of the coating layer.

Especially in the case where the water-soluble polymer is a polyvinyl alcohol resin, the water-swelling synthetic mica has high compatibility with the polyvinyl alcohol resin. In addition, in the case where mean area diameter of the water-swelling synthetic mica is preferably at 0.5 to 5 μm, more preferably at 1 to 3 μm and much more preferably at 1.5 to 2.5 μm, the water-swelling synthetic mica has higher compatibility with the polyvinyl alcohol resin.

In the case where the water-swelling synthetic mica has higher compatibility with the polyvinyl alcohol resin, the polyvinyl alcohol resin having a higher degree of polymerization can be used. When using the polyvinyl alcohol resin having a higher degree of polymerization, there can be obtained a film whose gas barrier properties is further improved. Specifically, in the case where mean area diameter of the water-swelling synthetic mica is at 0.5 to 5 μm, preferably at 1 to 3 μm and more preferably at 1.5 to 2.5 μm, the degree of polymerization of polyvinyl alcohol resin can be 1,100 or higher, and there can be obtained a film whose gas barrier properties is further improved.

The solid content ratio of the water-swelling mica or micas occupied in the total solid content of the coating layer is at 20 to 50 mass %, preferably at 30 to 45 mass % and more preferably at 35 to 40 mass %. If the solid content ratio of the water-swelling mica occupied in the total solid content of the coating layer is less than 20 mass %, satisfactory gas barrier properties are not obtained with respect to the coating layer. On the other hand, when the solid content ratios of the water-swelling mica occupied in the total solid content of the coating layer exceeds 50 mass %, the adhesion strength of the coating layer to a base material film and the cohesive strength of the coating layer are both lowered as time passes. In the case where the solid content ratios are outside the given ranges and the cohesive strength of the coating layer and the adhesion strength of the coating layer to a base material film are lowered with time, a packaging material having the coating layer is degraded in laminate strength with time.

While not being limited to this mechanism, it is believed that the higher the solid content ratios of the water-swelling mica, that the more satisfactory gas barrier properties are obtained with respect to the coating layer, but both of the adhesion strength of the coating layer to a base material film and the cohesive strength of the coating layer are lowered. However, by adjusting the average particle diameter of the water-swelling mica, it is possible to further heighten the solid content ratios of the water-swelling mica. As a result, it is possible to obtain a film with improved gas barrier properties while suppressing decrease in the adhesion strength of the coating layer to a base material film and the cohesive strength of the coating layer. Specifically, in the case where the solid content ratios of the water-swelling mica occupied in the total solid content of the coating layer is at 20 to 50 mass %, mean area diameter of the water-swelling mica is preferably at 0.5 to 5 μm, more preferably at 1 to 3 μm and much more preferably at 1.5 to 2.5 μm,

[Method for Forming the Coating Layer]

The coating layer comprised mainly of the water-soluble polymer and the water-swelling mica is formed by coating, on a base material film, a coating agent containing at least the water-soluble polymer and the water-swelling mica as main constituents according to a known wet coating process, followed by dry removal of a solvent component.

The coating agent primarily contains water as a solvent and may also contain a solvent dissolved in or uniformly mixed with water. The solvents include, for example, alcohols such as methanol, ethanol, isopropanol and the like, ketones such as acetone, methyl ethyl ketone and the like, ethers such as tetrahydrofuran and the like, cellosolves, carbitols, and nitriles such as acetonitrile and the like.

The wet coating methods used can include those of roll coating, gravure coating, reverse coating, die coating, screen printing, spray coating and the like. Using these wet coating methods, a coating agent is coated onto one or both of surfaces of a base material film. For drying the coating agent, there are used known drying methods including such as of hot air drying, hot roll drying, IR irradiation and the like.

The thickness of the coating layer formed on the base material film is set depending on the gas barrier properties required. The thickness of the coating layer formed on the base material film is preferably at 0.1 to 1 μm, more preferably at 0.15 to 0.7 μm, much more preferably at 0.2 to 0.5 μm. If the coating layer thickness is less than 0.1 μm, satisfactory gas barrier properties are unlikely to be obtained. On the other hand, when the coating layer thickness exceeds 1 μm, not only a difficulty is involved in providing a uniform coating surface, but also a drying load and production costs increase, thus being unfavorable.

The thickness of the coating layer formed on the base material film can be made thinner while the coating layer maintains sufficient barrier properties by adjusting the average particle diameter of the water-swelling mica. The reason is because the water-swelling mica is more uniformly dispersed in the coating layer by adjusting the average particle diameter of the water-swelling mica. Particularly, in the case where mean area diameter of the water-swelling synthetic mica is at 0.5 to 5 μm, preferably at 1 to 3 μm and more preferably at 1.5 to 2.5 μm, the thickness of the coating layer can be 1 μm or lower while the coating layer maintains sufficient barrier properties.

The coating layer may further contain a variety of additives within ranges not impeding gas barrier properties and strength as a packaging material. As an additive, mention is made, for example, of antioxidants, weathering agents, thermal stabilizers, lubricants, crystal nucleating agents, UV absorbers, plasticizers, antistatic agents, colorants, fillers, surfactants, silane coupling agents and the like.

[Ink Layer]

The ink layer is formed in order to be practically used as a packing bag or the like, and is a layer formed by ink in which various pigments, such as an extender pigment, additives, such as a plasticizer, a drying agent, or a stabilizer, are added to an ink binder resin that has been used in the related art, such as a urethane-based resin, an acryl-based resin, a cellulose nitrate-based resin, a rubber-based resin, or a vinyl chloride-based resin. Character, patterns, or the like are formed on the printing layer.

[Adhesive Layer]

For adhesives used as the adhesive layer, well-known adhesives, such as an acryl-based adhesive, a polyester-based adhesive, an ethylene vinyl acetate-based adhesive, a urethane-based adhesive, a vinyl chloride vinyl acetate-based adhesive, and a chlorinated polypropylene-based adhesive, can be used according to the materials of respective layers to be laminated. As coating methods of adhesives for forming the adhesive layer, well-known coating methods can be used. For example, a roll coater, a reverse roll coater, a photogravure coater, a micro-photogravure coater, a knife coater, a bar coater, a wire bar coater, a die coater, a dip coater, or the like can be used. As the coating amount of the adhesives, 1 to 10 g/m² is preferable.

[Anchor Coat Layer]

For an anchor coating agent used as the anchor coating layer, it is preferable that the anchor coating agent is selected, for example, from solvent-soluble or water-soluble polyester resins, isocyanate resins, urethane resins, acrylic resins, vinyl alcohol resins, ethylene vinyl alcohol resins, vinyl-modified resins, epoxy resins, oxazoline group-containing resins, modified styrene resins, modified silicone resins, or alkyl titanate, or the like. These may be used singly or in combination of two or more.

[Heat Seal Layer]

The heat seal layer serves as a bonding portion at the time of forming a packaging material. Examples of constituents of the heat seal layer include resins, such as polyethylene, polypropylene, an ethylene-vinyl acetate copolymer, an ethylene-methacrylic acid copolymer, an ethylene-methacrylic acid ester copolymer, an ethylene-acrylic acid copolymer, ethylene-acrylic acid ester copolymer, and metal crosslinked products thereof. The thickness of the heat seal layer is, for example, 15 to 200 μm.

### Examples

Examples and Comparative Examples are described to more particularly illustrate the invention, which should not be construed as limited to the following examples.

### Examples and Comparative Examples

For water-soluble polymer, polyvinyl alcohol resin (Selvol-325 with a degree of saponification of 98 to 99% and a degree of polymerization of 1700, manufactured by Sekisui Specialty Chemicals America, LLC.) was used. The polyvinyl alcohol resin and water were mixed, heated at 95° C., and the polyvinyl alcohol resin was dissolved in water. The mixtures were cooled down to room temperature, followed by diluting with water and isopropanol (at a mass ratio of 1:1) in such a way that a final solid concentration was made at 5 mass % thereby preparing components (A).

For the water-swelling mica, water-swelling synthetic micas (Somasif MEB-3, manufactured by Co-op Chemical Co., Ltd.) was used. The water-swelling synthetic micas at mean area diameters indicated in Tables 1 were prepared by use of a bead mill, followed by mixed with water in such a way that a final solid concentration was made at 8 mass % thereby preparing components (B).

The components (A) and (B) were formulated at solid content ratios of the water-swelling micas indicated in Tables 1, followed by diluting with water and methanol (at a mass ratio of 1:1) in such a way that a final solid concentration was made at 4.5 mass % thereby preparing coating agents.

The coating agents of Examples 1 to 9 and Comparative Examples 1 to 5 were each coated, by use of a gravure coater, onto an atmospheric pressure plasma-treated surface of biaxially stretched polypropylene film (CBP with a thickness of 20 manufactured by Toray Co., Ltd.) followed by drying by passage through an oven at 90° C. for 10 seconds, thereby obtaining gas barrier films of Examples 1 to 9 and Comparative Examples 1 to 5.

### Evaluation

[Measurement of Oxygen Permeability (Equal Pressure Method)]

The oxygen permeability (cm³/m²-day-atm) was measured under conditions of 30° C. and 70% RH using an oxygen permeability measuring device MOCON (OX-TRAN2/21, made by Modern Controls, Inc.). The results of the measurement of oxygen permeability of the gas barrier films are shown in Table 2.

[Measurement of Water Vapor Permeability]

The water vapor permeability (g/m²-day) was measured under conditions of 40° C. and 90% RH using a water vapor permeability measuring device PERMATRAN W-3/33MG (made by Modern Controls, Inc.). The results of the measurement of water vapor permeability of the gas barrier films are shown in Table 2.

[Measurement of Laminate Strength]

A 30 μm thick unstretched polypropylene film (CPP GLC, manufactured by Mitsui Chemicals Tocello, Inc.) having an ink layer was laminated on the respective gas barrier films of Examples 1 to 9 and Comparative Examples 1 to 5. The unstretched polypropylene film was laminated on a coating side (on a surface to be coated) of the gas barrier films by dry lamination through a polyester polyurethane adhesive (Takelac A-525, manufactured by Mitsui Chemicals, Inc./Takenate A-52, manufactured by Mitsui Chemicals, Inc.) so that the ink layer and the coating side are adjacent to each other, followed by aging at 40° C. for 48 hours to obtain packaging materials. The packaging materials was cut into a 15 mm wide strip, followed by subjecting to 90° peeling at a rate of 300 mm/minute by means of a tensile tester Tensilon to measure laminate strength. The results are shown in Table 2.

[Measurement of Haze]

Examples 1 to 9, the gas barrier films of Comparative Examples 1 to 5 were measured haze (%) using a haze meter (NDH-2000, Nippon Denshoku Industries Co., Ltd.). The results are shown in Table 2.

TABLE 1

| | Water-swelling Synthetic Micas | | |
|---|---|---|---|
| | Solid Content | Mean Area | Thickness of the |
| | Ratios [mass %] | Diameter [μm] | Coating Layer [μm] |
| Example 1 | 20 | 2 | 0.35 |
| Example 2 | 30 | 2 | 0.35 |
| Example 3 | 35 | 2 | 0.35 |
| Example 4 | 50 | 2 | 0.35 |
| Example 5 | 35 | 0.5 | 0.35 |
| Example 6 | 35 | 5 | 0.35 |
| Example 7 | 35 | 2 | 0.1 |
| Example 8 | 35 | 2 | 0.7 |
| Example 9 | 35 | 2 | 1 |
| Comparative | 10 | 2 | 0.35 |
| Example 1 | | | |
| Comparative | 60 | 2 | 0.35 |
| Example 2 | | | |
| Comparative | 35 | 10 | 0.35 |
| Example 3 | | | |
| Comparative | 35 | 2 | 0.01 |
| Example 4 | | | |
| Comparative | 35 | 2.0 | 0.05 |
| Example 5 | | | |

TABLE 2

| | Oxygen | Water Vapor | Laminate | |
|---|---|---|---|---|
| | Permeability | Permeability | Strength | Haze |
| | [cm³/m² · day · atm] | [g/m² · day] | [N/15 mm] | [%] |
| Example 1 | 6.245 | 1.949 | 1.6 | 1.7 |
| Example 2 | 2.458 | 1.454 | 1.25 | 1.7 |
| Example 3 | 2.029 | 1.435 | 1 | 1.7 |
| Example 4 | 3.537 | 1.728 | 0.35 | 1.8 |
| Example 5 | 2.205 | 1.436 | 1 | 1.7 |
| Example 6 | 10.2 | 1.56 | 1 | 4.1 |
| Example 7 | 13.116 | 2.201 | 1.3 | 1.7 |
| Example 8 | 0.6 | 1.561 | 0.6 | 2.0 |
| Example 9 | 0.61 | 1.609 | 0.5 | 2.5 |
| Comparative | 13.652 | 2.152 | 2 | 1.6 |
| Example 1 | | | | |
| Comparative | 5.245 | 1.953 | 0.1 | 2 |
| Example 2 | | | | |
| Comparative | higher than 100 | 3.2 | 1 | 35.8 |
| Example 3 | | | | |
| Comparative | higher than 100 | 3.1 | 1.8 | 1.6 |
| Example 4 | | | | |
| Comparative | 30.6 | 2.397 | 1.3 | 1.5 |
| Example 5 | | | | |

The above results indicate that the gas barrier films in which the solid content ratios and the mean area diameter of the water-swelling mica and the thickness of the coating layer are in specific ranges can be low in oxygen permeability, in water vapor permeability and in haze, and that the gas barrier property and the transparency of the gas barrier film can be improved. In addition, the above results indicate that packaging materials using the gas barrier films in which the solid content ratios and mean area diameter of the water-swelling mica and the thickness of the coating layer are in specific ranges are high in lamination strength, and the cohesive strength of the coating layer of the gas barrier film and the adhesion strength of the coating layer to the substrate can be improved.

What is claimed is:

1. A gas barrier film comprising:
a first base material film made of a plastic material; and
a coating layer formed on one of surfaces of the first base material film,
wherein the coating layer contains a water-soluble polymer and a water-swelling mica,
wherein the solid content ratios of the water-swelling mica in a total solid content of the coating layer are within approximate ranges indicated from 20 mass % to 50 mass %,
wherein the mean area diameter of the water-swelling mica is within approximate ranges indicated from 0.5 μm to 5 μm, and
wherein the thickness of the coating layer is within approximate ranges indicated from 0.1 μm to 1 μm.

2. The gas barrier film of claim 1,
wherein the water-soluble polymer is polyvinyl alcohol resin and
wherein the degree of polymerization of the polyvinyl alcohol resin is within approximate ranges indicated from 1,100 to 2,300.

3. The gas barrier film of claim 1,
wherein the aspect ratio of the water-swelling mica is within approximate ranges indicated from 10 to 200.

4. The gas barrier film of claim 1,
wherein the mean area diameter of the water-swelling mica is within approximate ranges indicated from 1.5 μm to 2.5 μm and
wherein the thickness of the coating layer is within approximate ranges indicated from 0.15 μm to 0.7 μm.

5. A packaging material comprising:
a first film;
a second film; and
an adhesive layer formed between the first film and the second film,
wherein the first film comprises a first base material film made of a plastic material and a coating layer formed between the first base material film and the adhesive layer,
wherein the second film comprises a second base material film made of a plastic material,
wherein the coating layer comprises a water-soluble polymer and a water-swelling mica,
the solid content ratios of the water-swelling mica in a total solid content of the coating layer are within approximate ranges indicated from 20 mass % to 50 mass %,
the mean area diameter of the water-swelling mica is within approximate ranges indicated from 0.5 μm to 5 μm, and
the thickness of the coating layer is within approximate ranges indicated from 0.1 μm to 1 μm.

6. The packaging material of claim 5,
wherein the second film comprises an ink layer formed between the second base material film and the adhesive layer.

7. The packaging material of claim 5,
wherein the first film comprises an ink layer formed between the coating layer and the adhesive layer.

8. The packaging material of claim 5,
wherein the first base material film and the second base material film are made of a same plastic material.

9. The packaging material of claim 5,
wherein the water-soluble polymer is polyvinyl alcohol resin and
wherein the degree of polymerization of the polyvinyl alcohol resin is within approximate ranges indicated from 1,100 to 2,300.

10. The packaging material of claim 5,
wherein the aspect ratio of the water-swelling mica is within approximate ranges indicated from 10 to 200.

11. The packaging material of claim 5,
wherein the mean area diameter of the water-swelling mica is within approximate ranges indicated from 1.5 μm to 2.5 μm and
wherein the thickness of the coating layer is within approximate ranges indicated from 0.15 μm to 0.7 μm.
